(19) United States
(12) Patent Application Publication
(10) Pub. No.: US 2020/0032962 A1
(43) Pub. Date: Jan. 30, 2020

(54) FLUID-MONITORING PROBE, BAFFLE AND SYSTEM

(71) Applicant: JDSE Limited, Shrewsbury Shropshire (GB)

(72) Inventor: Jeremy KNIGHT, Market Drayton Shropshire (GB)

(21) Appl. No.: 16/498,322

(22) PCT Filed: Mar. 27, 2018
(86) PCT No.: PCT/GB2018/050792

§ 371 Date: Sep. 26, 2019

(30) Foreign Application Priority Data
Mar. 27, 2017 (GB) 1704827.3

(51) Int. Cl. F17D 3/10; F17D 3/01

(52) U.S. Cl. CPC F17D 3/10; F17D 3/01

(57) ABSTRACT

A fluid monitoring system (10) is suitable for the monitoring of liquefied natural gas in a pipe section (12), via insertion of a fluid-monitoring probe(14) into a port (16). The fluid-monitoring probe (14) is at least partially covered by a support structure (18), and a fluid-directing baffle (20) is mounted thereon to redirect fluid flow from the main liquefied gas flow to a secondary passage through the support structure.

The present invention relates to a system for monitoring a liquefied natural gas pipeline by intermittent or continuous sampling, and also a fluid-monitoring-probe assembly for application in such a system.

Sampling of low temperature liquid from a liquefied natural gas pipeline is necessary to accurately determine the composition of the fluid flow. Furthermore, it is often important to monitor the temperature of the fluid flow of a liquefied natural gas pipeline to ensure safe liquefied natural gas transit.

Presently, liquefied natural gas is typically extracted from a liquefied natural gas pipeline at a monitoring point using a sampling probe. The captured liquefied natural gas is subsequently vaporised to give a gas at ambient temperature to be analysed by gas chromatography. It is essential in this process that there is no loss of any constituent fractions; this is difficult to ensure due to the ease of partial vaporisation of many fractions, which are very close to their boiling points at the operational temperature of the liquefied natural gas pipeline. Hence it is desirable for the liquefied natural gas to be sub-cooled on sampling. However, this is difficult to achieve as a liquefied gas sample is typically in relatively poor thermal communication with the bulk liquefied gas flow during the sampling process.

Another important issue in extracting liquefied natural gas from an operational liquefied natural gas pipeline is capturing an original sample with composition representative of the fluid flow. Due to varying densities and viscosities of the constituent chemical fractions of the liquefied natural gas, some stratification may occur in the fluid flow. The liquefied gas flow in the central portion of the pipeline will be fastest and most turbulent, and hence best mixed.

It is therefore advantageous to sample from a point on the central bore axis of the pipeline, rather than from near the interior surface where the liquefied gas is most likely to be unrepresentative of the average composition, due to low flow viscosity and interactions with the surface. Currently, it is typical for probes in industrial application to extend between one thirds and two thirds of the diameter of the pipe cross-section.

However, excessively long probes, as required for large pipelines, can be disadvantageous, principally as they can be fragile.

Similar considerations apply in the case of temperature monitoring of a liquefied natural gas pipeline, where the sample probe is replaced with a thermowell. In this case, maintaining thermal equilibrium between the liquefied gas flow and the captured liquefied gas is often important.

The liquefied natural gas can be extracted continuously or intermittently. Continuous sampling methods are most common, although intermittent sampling methods are still typically used for impurity analysis of liquefied natural gas, and are often used as back-up systems in case of the failure of a continuous sampling system.

ISO standard 8943 covers appropriate apparatus and procedures for the monitoring of liquefied natural gas pipelines.

The object of this invention is to provide a method of monitoring a liquefied natural gas pipeline which ensures a subcooled and compositionally representative sample, and hence solves the problems with the prior art outlined above.

According to a first aspect of the invention there is provided a liquefied natural gas monitoring system, comprising a section of a liquefied natural gas pipeline including a main throughbore, an access port having a neck portion at least partially external to the main throughbore, a fluid-monitoring probe insertable via the access port, and a fluid-directing baffle mountable at or adjacent to the fluid-monitoring probe so as to direct the liquefied natural gas from the main throughbore of the pipeline into the neck portion of the access port, around the fluid-monitoring probe.

Preferably, the fluid-directing baffle may typically be mounted on one of the sealing flange of the access port and/or interior surface of the pipe. This is advantageous in that it allows the provision of larger baffles of more complex shapes which may not be easily insertable into the access port of a liquefied natural gas pipeline.

Preferably, the fluid-monitoring probe may comprise an elongate monitoring element. The monitoring element of a fluid-monitoring probe for a liquid natural pipeline is preferably elongate in order to be able to monitor a representative portion of the volume of the pipeline.

It is also preferable that the fluid-directing baffle may further be directly mounted on the fluid-monitoring probe. A baffle mounted on the fluid-monitoring probe is advantageous in that it may be retractable with the probe. This allows for facile monitoring of the condition of the baffle, and replacement if required. Mounting the baffle specifically on the probe body results in a compact fluid-monitoring-probe assembly.

Preferably, the elongate monitoring element may be at least partially enclosed by a support structure. The presence of a support structure around the elongate monitoring element may help to ensure that the elongate monitoring element monitors liquefied natural gas which is representative of the bulk liquefied natural gas flow. It also may protect the elongate monitoring element during insertion and retrieval of the fluid-monitoring probe into and out of the pipeline.

Advantageously, the fluid-directing baffle may be mounted on the support structure. This design is similar in effect to mounting the fluid-directing baffle on the probe body, with additional advantages including greater freedom to modify the properties of the support structure for compatibility with the fluid-directing baffle, and that the support structure may provide further definition to the fluid passage around the fluid-monitoring probe.

Preferably, the support structure may include a plurality of apertures, which provide definition to the fluid passage around the fluid-monitoring probe, and may be modified in size, shape and number to change the velocity and turbulence, among other properties, of the flow around the fluid-monitoring probe.

The support structure preferably may include at least two apertures distal to the main throughbore of the pipe, to provide a fluid conduit path through the neck portion of the access port and via the support structure. Additionally or alternatively, the fluid-directing baffle may include at least one aperture alignable with the apertures of the support structure. This design further defines the flow path around the fluid-monitoring probe.

The baffle preferably may be integrally formed with the support structure. This is beneficial for reducing fabrication costs and avoiding potential weak points where the baffle is mounted to the support structure. Furthermore, the baffle may be further provided as an asymmetrical extension of the support structure. Such a design may optimize the dynamic properties of the baffle.

Beneficially, the exterior of the access port and/or fluid-monitoring probe may include an indicator or indicators of the direction of fluid flow. Among other advantages, this allows the user to correctly insert or orient the fluid-directing baffle, since incorrect insertion of the baffle potentially results in damage to the baffle and/or fluid-monitoring probe. Preferably, the fluid-directing baffle may therefore be aligned relative to the direction of fluid flow with respect to indicia provided by the system.

The fluid monitoring baffle may advantageously be concave. This design provides a curved flow path around the surface, as well as greater strength.

However, the fluid-directing baffle may be a flat or substantially flat plate, as this design is economical to produce and provides at least substantially suitable dynamic properties.

According to a second aspect of the invention, there is provided a fluid-monitoring-probe assembly which comprises a fluid-monitoring probe for engaging with a pipe to be monitored, and a fluid-directing baffle which is mountable at or adjacent to the fluid-monitoring probe, so as, in use, to direct the fluid from the pipe around the fluid-monitoring probe.

The fluid-monitoring probe may preferably comprise a probe body. In this case, the fluid-directing baffle may be mounted directly on the probe body.

The probe body may be at least partially enclosed by a support structure. In this case, the fluid-directing baffle may preferably be mounted on the support structure. Additionally or alternatively, the support structure may preferably include a plurality of apertures.

The support structure may preferably include at least two apertures distal to the main throughbore of the pipe, to provide a fluid conduit path through the neck portion of the access port and via the support structure.

Preferably, the exterior of the fluid-monitoring probe may include an indicator or indicators of the direction of fluid flow. As with the location of an indicator or indicators of the direction of fluid flow on the access port, this allows the user to correctly insert or orient the fluid-directing baffle. Preferably, the fluid-directing baffle may therefore be aligned relative to the direction of fluid flow with respect to indicia provided by the system.

The elongate monitoring element may advantageously be a thermowell. The elongate monitoring element may also or alternatively preferably be a liquefied natural gas sampling tube. In all cases, the fluid-monitoring-probe assembly may be provided as a kit of parts, to advantageously facilitate custom construction of a fluid-monitoring-probe assembly for a particular pipeline or particular access port of a specific pipeline, and to allow for the replacement of damaged or worn components.

According to a third aspect of the invention, there is provided a fluid-conduit baffle assembly for a fluid-monitoring-probe assembly having a fluid-monitoring probe and inside a fluid transfer conduit, the fluid-conduit baffle assembly comprising a support structure to which the fluid-monitoring probe can be mounted inside the fluid transfer conduit; and a fluid-directing baffle which is mountable to the support structure to direct fluid around or through the support structure.

Preferably, the support structure may include a plurality of apertures. Furthermore, the support structure preferably may include two or more mutually opposed apertures, to provide a fluid conduit path through the neck portion of the access port and via the support structure. The baffle may preferably be a flat plate, concave, or a combination thereof.

The baffle preferably may extend beyond the support structure. A longer baffle advantageously allows the redirection of more homogenous liquefied gas flow from the central section of the pipeline towards the secondary fluid passage, and thus improves the representativeness of the liquefied gas monitored and/or sampled.

The fluid-conduit baffle assembly may preferably be provided as a kit of parts, to advantageously facilitate custom construction of a fluid-conduit baffle assembly for a particular pipeline, and to allow for the replacement of damaged or worn components.

Alternatively, the fluid-conduit baffle assembly may preferably be formed unitarily in order to reduce production costs and avoid the presence of structurally weak points. The baffle may be further provided as an asymmetric extension of the support structure.

According to a fourth aspect of the invention, there is provided a method of maintaining sub-cooled fluid at or within a fluid-monitoring probe in use on a liquefied natural gas pipeline, comprising the steps of: a) providing a fluid-directing baffle; and b) mounting said fluid-directing baffle at or adjacent to a fluid-monitoring probe such that it redirects fluid from the main fluid-flow around the fluid-monitoring probe.

This method advantageously allows for the recordal of an accurate temperature by a thermowell partially inserted into a liquefied natural gas pipeline, or the maintenance of sub-cooling in sampled liquefied natural gas. Preferably, the fluid-directing baffle may be mounted on a support structure including a plurality of apertures to define a secondary fluid flow passage.

The invention will now be more particularly described, by way of example only, with reference to the accompanying drawings, in which:

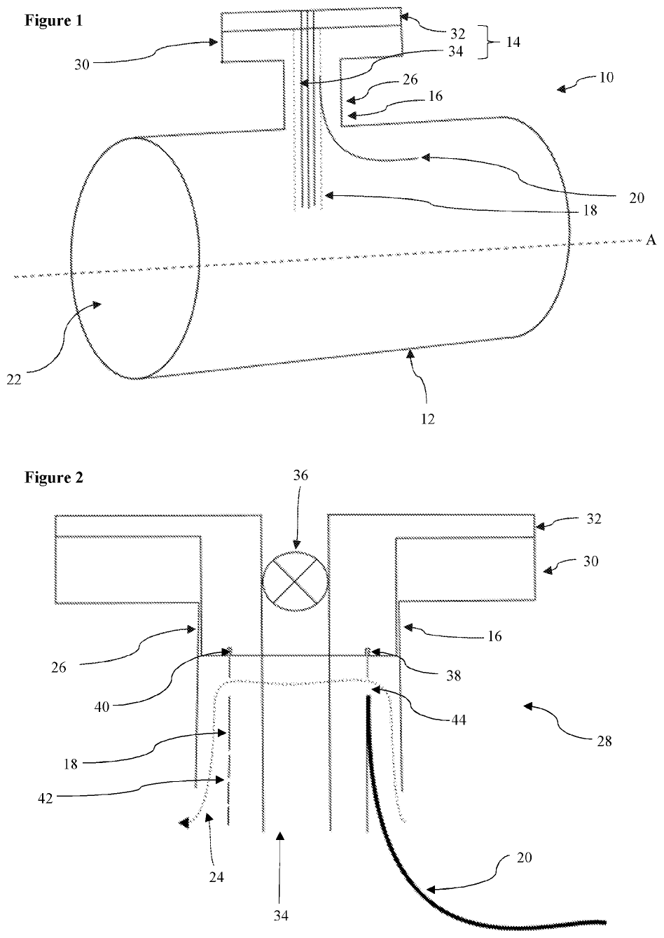

FIG. 1 shows a perspective representation of a first embodiment of a liquefied natural gas pipeline monitoring system, in accordance with the first aspect of the present invention;

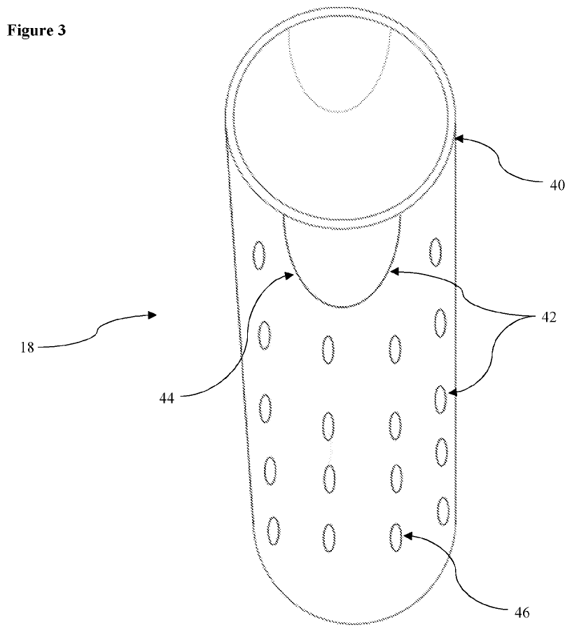

FIG. 2 shows an enlarged longitudinal cross-section through a port of a pipe-section having an associated fluid-monitoring-probe assembly, in accordance with the second aspect of the present invention and usable as part of the liquefied natural gas pipeline monitoring system of FIG. 1;

FIG. 3 shows a perspective representation of a support structure for the fluid-monitoring-probe assembly of FIG. 2;

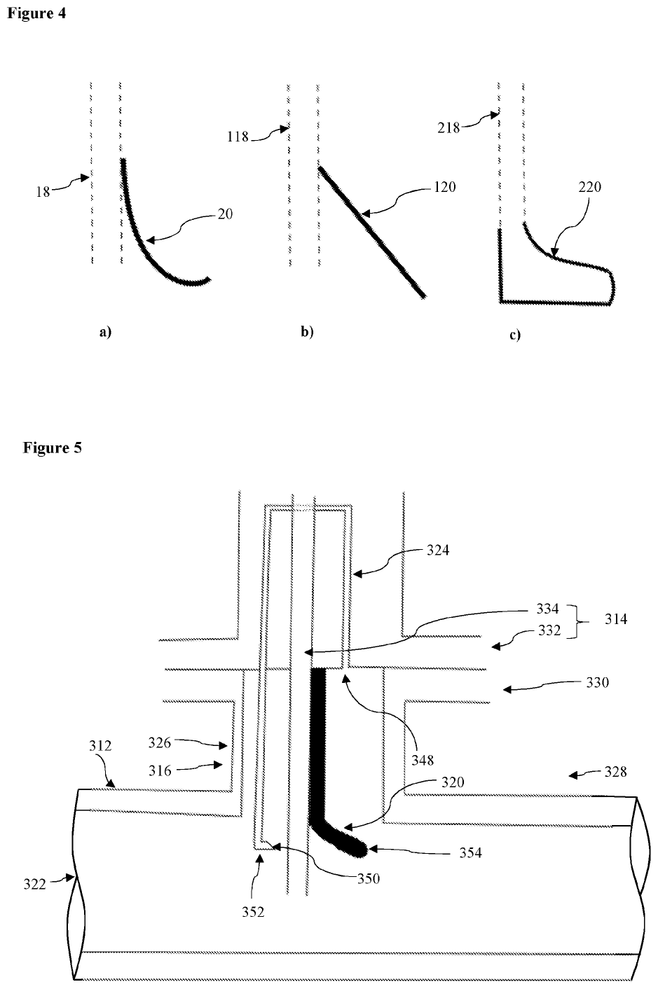

FIG. 4(a) shows a schematic longitudinal cross-section of a first embodiment of the fluid-conduit baffle assembly, usable as part of the fluid-monitoring-probe assembly of FIG. 2, in accordance with the third aspect of the present invention;

FIG. 4(b) shows a schematic longitudinal cross-section of a second embodiment of the fluid-directing baffle and support structure assembly, in accordance with the third aspect of the present invention;

FIG. 4(c) shows a schematic longitudinal cross-section of a third embodiment of a baffle and support structure assembly, in accordance with the third aspect of the invention; and

FIG. 5 shows an enlarged diagrammatic cross-section of a second embodiment of a fluid-monitoring-probe assembly, in accordance with the first and second aspects of the invention.

Referring to firstly to FIGS. 1 to 3 and 4(a) of the drawings, there is shown a fluid monitoring system, indicated globally by 10, preferably but not necessarily exclusively for the monitoring of liquefied natural gas in a pipe section 12 of a pipeline, via insertion of a fluid-monitoring probe 14 into an access port 16. The fluid-monitoring probe 14 is partially covered by a support structure 18, on which is mounted a fluid-directing baffle 20, designed to redirect fluid flow from the main liquefied gas flow in a main throughbore 22 to a secondary passage or fluid conduit 24. The fluid-monitoring probe 14, support structure 18 and fluid-directing baffle 20 are herein collectively referred to as the fluid-monitoring-probe assembly 28.

The pipe section 12 is preferably cylindrical or substantially cylindrical, and may include an access port 16. In a preferred embodiment of the invention, a neck portion 26 of the access port 16 extends externally from the pipe section 12, and may terminate in an inlet element 30. The neck portion 26 preferably has a substantially circular or elliptical cross-section, but a variety of other shapes would also be evident to a person skilled in the art. The neck portion 26 is preferably orientated so that the fluid-monitoring probe 14 can be inserted into the pipe section 12 perpendicularly to its bore axis A. The inlet element 30 is preferably provided as a flange element, adapted to be engagable with the fluid monitoring probe 14.

The inlet element 30 is here shown connected to a fluid-monitoring probe 14 via a first proximal probe body 32 thereof. While preferably the inlet element 30 and probe body 32 may be formed at least in part as matable flange elements, as shown in FIG. 1 and as hereafter referenced, they may also be preferably provided as screw-threaded elements, optionally via a bushing, or elements suitable for sealing via a clamp joint or a bell and spigot joint. Other designs may also be evident to the skilled person, such as a ring-slot engagement as disclosed in U.S. Pat. No. 3,704,901. The flange elements 30 and 32 may preferably be temporarily affixed by bolts and associated holes on the two flange elements 30 and 32, but could alternatively be welded together or otherwise sealed. The proximal probe body flange element 32 may also comprise a valve, and therefore may also be referred to as a valve flange element.

The fluid-monitoring probe 14 preferably also comprises a second distal probe body 34, which preferably is provided as an elongate monitoring element, and may extend through the neck portion 26 of the access port 16, to contact the liquid flow of the pipe section 12. The first probe body 32 and second probe body 34 may be integrally formed or welded together. Alternatively, the second probe body 34 may be removably engagable with the first probe body 32 by means of a screw-threaded connection.

In the depicted embodiment of the invention, the fluid-monitoring probe 14 is a liquefied gas sampling device. In this case, the second probe body 34 is preferably provided as a tube, open at its end proximal to the throughbore 22, and insertable into a liquefied gas flow at low temperature, in order to capture a volume of liquefied natural gas of representative composition of the gas flow.

Alternatively, the fluid-monitoring probe may be a thermowell. In this case, the second probe body is preferably provided as a tube, closed at one end to provide a cavity or elongate conduit extending along the longitudinal extent of the second probe body, suitable for inserting a temperature measurement device. The temperature measurement device may preferably be a thermocouple or a resistance thermometer.

Preferably the second probe body 34 is formed of metal; suitable materials include stainless steels, high carbon steels, and nickel-based performance alloys. However, it may also be appropriate to manufacture the second probe body from chemically inert plastics, especially medium-density polyethylene. The material of the tube must retain tensile strength at cryogenic temperatures, and thus austenitic stainless steels, which do not have a ductile-brittle transition at low temperatures, may be particularly preferred. The second probe body 34 may also preferably be constructed out of polytetrafluoroethylene (PTFE) due to its high corrosion resistance.

If the second probe body 34 is a fluid sampling probe, a ball valve or valves can be used to control fluid communication from the probe to a suitable sampling container (not shown). Preferably, the first probe body 32 includes a screw-threaded connection on the exterior opening of the second probe body 34, to allow the attachment of a valve module (not shown) including one or more valve elements, such as a ball/aperture valve.

The probe flange element 32 may also contain an integral valve module, or alternatively contain one or more valve elements, such as a ball/aperture valve, indicated schematically on FIG. 2 by 36. It may be appropriate to use or include other valves, instead of or additional to the ball valve or valves, in the probe flange element 32; for instance, a butterfly valve, check valve, globe valve or needle valve.

The probe flange element 32 preferably further has a groove 38 adapted to be engagable to a rim 40 of the support structure 18, so that the support structure 18 may be mountable on the probe flange element 32.

For the correct insertion of the second probe body 34, the direction of the fluid flow may be determined by an indicator or indicators (not shown) integrated into the access port 16 or the pipe section 12, with indicia displayed on or proximal to the access port 16. The indicator could also provide indicia of flow velocity as well as direction, as discussed above, if a flow monitor or sensor were to be provided.

Furthermore, if the pipeline is constructed modularly for a particular direction of liquefied natural gas transit, it may be preferable for indicia of the flow direction to be stamped on the pipe section 12 proximal to the access port 16, or provided via an attached metal plaque or plastic laminate sticker. If the access port 16 is constructed specifically for the fluid monitoring system of the present invention, it may be appropriate to integrate such indicia into the design of the access port 16, so that it is only possible to insert the fluid-monitoring probe 14 such that the fluid-directing baffle 20 faces in the correct direction of liquefied natural gas transit.

The design of the access port 16 and the probe flange element 32 may also preferably be harmonized so that the probe flange element 32 bears one or more further indicators, or further indicia the direction of fluid flow. Alternatively, the probe flange element 32 may be the only element to display an indicator, indicators or indicia of the direction of fluid flow.

The support structure 18 is preferably formed as a sheath, which covers or partially covers the second probe body 34 of the fluid-monitoring probe 14. The coverage may only extend in or substantially in the neck portion 26 to prevent or reduce turbulence in the fluid flow within the main throughbore 22. Optionally, the support structure 18 itself may include one or more spaced apart, preferably integrally formed, helical or spiral fins along all or a part of a longitudinal extent of the support structure 18 to mitigate turbulence. The fins are preferably integrally formed as one-piece with the support structure 18, and may only be present in the extent of the sheath which projects into the main throughbore 22.

The support structure 18 is preferably formed from material suitable for cryogenic applications. The support structure 18, in this embodiment, includes multiple apertures 42 in order to allow fluid passage through the support structure 18. In this case it may be preferable for the support structure 18 to entirely enclose the second probe body 34, so that the fluid sampled passes through the support structure 18. The support structure is here shown as being attached to the probe flange element 32, but may also preferably be attached directly to the fluid-monitoring probe 14 via the second probe body 34. The support structure 18 may preferably feature a region devoid of apertures 42 suitable for mounting the fluid-directing baffle 20.

The support structure 18 most preferably includes two mutually opposed first apertures 44 so as to be disposed or positioned either side of the second probe body 34 when received in the support structure 18, at a point distal to the main throughbore 22 of the pipe section 12, and aligned with respect to the fluid-directing baffle 20. The first apertures 44 may preferably be provided with semi-elliptical or substantially semi-elliptical cross-section, and are sufficient to define the secondary passage or fluid conduit 24 around the second probe body 34 in operation.

In this case, the support structure 18 may preferably have a further plurality of second apertures 46, proximal to the main throughbore 22 of the pipe section 12. The second apertures 46 may preferably be provided as holes with elliptical or substantially elliptical cross sections. The second apertures 46 may furthermore advantageously diminish the Venturi reduction in fluid pressure, reducing the risk of cavitation and thus increasing the lifetime of the system. However, they may also increase the turbulence of the flow through the secondary conduit 24. Preferably, between 20% and 60% of the surface area of the support structure 18 may be occupied by the second apertures 46, and most preferably 40% or around 40%. The two mutually opposed first apertures 44 distal to the main throughbore 22 of the pipe section 12 are preferably significantly larger than the second apertures 46 proximal to the main throughbore of the pipe section 12, and most preferably of a major axis ratio of 4:1.

Alternatively, the support structure 18 may have more than two distally-located apertures, and preferably also a further plurality of proximally-located apertures. Any other configuration of apertures may be appropriate providing a fluid path through the support structure is defined, and which preferably encourages fast, turbulent flow. Other shapes or sizes of apertures may also be appropriate; the configuration shown in FIG. 3 is preferred for the technical reasons outlined above.

The support structure 18 is preferably constructed from a steel or performance nickel alloy pipe. It may also be possible to provide a support structure as a wire or polymer mesh.

In either case some or all of the apertures may have rims, nozzles or other integral features to modify the properties and direction of the turbulent flow of liquefied natural gas through the secondary passage. Furthermore, the smaller, preferably elliptical or substantially elliptical second apertures 46, may preferably have bores formed perpendicular to the central bore axis of the support structure 18. However, it may also be advantageous for the bores of the said second apertures 46 to be orientated at another angle relative to a central bore axis of the support structure 18, to direct the flow current in the secondary passage or fluid conduit 24.

The walls of the support structure 18 may be uniformly thick, with the exception of the rim 40. In other preferable embodiments, the walls may taper in the inner surface of support structure, maintaining a constant outer diameter.

Another preferable embodiment of the support structure 18 may be integrally formed with the baffle 20, or alternatively may be releasably engagable.

In the preferred embodiment of the invention, the rim 40 of the support structure 18 may preferably be adapted to fit into the corresponding groove 38 on the probe flange element 32 of the fluid-monitoring-probe assembly 28. The support structure 18 could also be attachable to the probe flange element 32 via a screw-threaded connection or by other methods.

In order to accurately sample the composition of the fluid flow at any given monitoring point at the pipeline, it is essential for the sample measured by the second probe body 34 to be representative of the bulk liquefied gas flow. It is also required that the sample, captured in the second probe body 34, remains at the same temperature of the bulk fluid flow until isolated, to avoid premature vaporisation of low-boiling point fractions. Temperature-dependent changes in density of liquid fractions may also result in poor sampling of the composition.

Therefore, there is included the fluid-directing baffle 20, which may preferably be attached to the support structure 18, positioned around the second probe body 34. The baffle may also be attached directly to the second probe body 34, or to an interior surface of the pipe section 12. Preferably, if the baffle 20 is attached to the support structure 18, it may extend past the support structure 18 into the main throughbore 22 of the pipe section 12. The baffle advantageously redirects fluid from the throughbore 22 of the pipe section 12 through the secondary channel 24, thus cooling the fluid-monitoring probe 14.

Referring to FIG. 4(a) and also as illustrated in FIGS. 1 and 2, in a preferable embodiment of the baffle 20 may be formed as a concave plate, so as to provide a curved flow path around its surface, ending at one of the large distal apertures of the support structure 18. It is particularly advantageous to have a baffle embodied as a concave plate, as this shape is efficient in terms of strength; the baffle is in tension due to the pressure of the oncoming fluid, and additionally the pressure differential created by the secondary fluid path. As shown, the curvature may be non-uniform, such as parabolic, having a smaller or tighter radius distally, and a greater or slacker radius proximally.

The curvature may be in a single dimension, as shown in FIG. 4(a) and as such in a plane which includes a longitudinal axis of the support structure and/or probe. The mutually perpendicular extent is therefore preferably straight or flat. Alternatively, the mutually perpendicular extent may also be curved, whereby the baffle forms a dished-shape. In this latter case, the curvature may be uniform or non-uniform, and in the case of non-uniformity, the curvature may produce a funnel tapering towards the proximal end of the probe or support structure.

The baffle 20 may be releasably attached to the support structure 18 by bolting it in place. It may also be permanently attached by riveting or welding, brazing and other such methods. The appropriate thickness of the baffle 20 may be determined by projected lifetime and corrosion allowance. The baffle 20 preferably is attached to a specifically designated section of the support structure 18 which lacks apertures. However, the baffle 20 may preferably include one or more apertures, preferably such that the apertures on the baffle are aligned with those on the support structure on fabrication of the fluid-monitoring-probe assembly. This design may be preferable as the presence of holes on the baffle 20 may allow for the introduction of further turbulence to the liquefied gas flow through the secondary passage or fluid conduit. In one possible embodiment of the invention the baffle 20 covers or substantially covers the surface of one hemi-cylindrical section of the support structure 18 such that the secondary passage or fluid conduit is defined through a single aperture on the baffle 20 which overlaps with the large distal aperture 44 on the support structure 18 proximal to the baffle 20.

The baffle 20 is preferably oriented so that a tangent to its surface at the point distal to the location of mounting is at an angle between 20 and 140 degrees, and most preferably approximately 90 degrees from the support structure 18.

It may be possible to provide a said baffle mounted to the interior of the pipeline 12 before the neck portion 26 of the access port 16, although in that case it may be necessary to provide an aperture on the baffle 20 to allow fluid communication with the aforementioned secondary passage 24.

The function of the baffle 20 is to redirect fluid flow from the main throughbore 22 of pipe section 12 into the secondary passage 24, defined around the second probe body 34, preferably but not necessarily within the neck portion 26 of the access port 16. This advantageously results in sub-cooled liquefied natural gas flowing through the secondary passage and cooling the second probe body 34 and/or a sample captured within it to the equilibrium temperature of the main liquefied natural gas flow. The turbulent flow in and around the secondary passage 24 results in highly homogenous gas flow to the second probe body 34, and thus superior, compositionally representative samples.

Preferably, the baffle 20 is designed such that the liquefied natural gas flow through the secondary passage 24 is faster and more turbulent than the gas flow through the main throughbore 22. This can be achieved by designing the baffle 20 such that a pressure differential is created across the region containing the second probe body 34, such that a high-pressure region exists at an entry of the secondary passage 24, and a low-pressure region exists at an exit. However, the baffle 20 and secondary passage 24 must be designed so that the pressure differential is not too great, to avoid failure of the pipe at or proximal to the access port 16. Cavitation events, which may occur if the secondary passage is too narrow, are a particular concern, and may significantly reduce the lifetime of affected components.

The baffle 20 preferably is manufactured from metal suitable for application in cryogenic contexts, such as, but not limited to, austenitic stainless steel or performance nickel alloys. Furthermore, it may be appropriate to surface treat the material of the baffle. Suitable methods include plasma treatment to improve hardness, and thermally sprayed or ceramic coatings to improve erosion resistance. A uniform, substantially uniform or non-uniform coating may also be applied to optimize the shape of the baffle 20 for the dynamics of the system. The surface may further be treated to gain a desired performance improving-texture. Similar treatments may be appropriate for other components of the fluid-monitoring-probe assembly 28.

FIGS. 4(b) and 4(c) show diagrammatic cross-sections of two alternative embodiments of baffles engaged or engagable with support structure, probe, neck portion and/or pipe.

Referring to FIG. 4(b), a second embodiment of the baffle 120 may be formed as an unperforated flat plate, and attached to the support structure 118 according to any one of the methods described above. A flat or planar baffle may be less efficient in terms of strength than a curved baffle, but may be more advantageous due to the lower costs of manufacturing to a high technical standard. Additionally, a flat baffle tends to cause greater disturbance of the liquefied gas flow, resulting in a more homogenous liquefied gas sample than a curved design, if the baffle is positioned correctly. Although planar in two mutually perpendicular axes, being a longitudinal plane which includes the longitudinal axis of the support structure and/or probe, and a lateral plane at right angles thereto, the lateral plane may be curved or arcuate, and such a curvature may be uniform or substantially uniform across the entire longitudinal extent of the baffle, or may be converging or diverging.

The baffle 120 is preferably oriented at an angle of between 20 and 90 degrees from the support structure 118, and most preferably between an angle of 40 and 70 degrees.

Referring to FIG. 4(c), a third embodiment of a baffle 220 may preferably be integrally formed with a support structure 218. Preferably, the baffle 220 may be provided as an asymmetric extension of the support structure 218. This is advantageous as it allows for the economic production of the one-piece support structure 218 and baffle 220 via hot-metal spin forming or other suitable techniques.

Various other designs and orientations of baffles may be appropriate, to cause a diversion of fluid from the main liquefied gas flow to the secondary passage.

More generally, due to the complexity of prediction of the behaviour of turbulent fluid around curved or irregular objects, it may also be advantageous to provide a curved baffle, integrated with or attachable to the support structure, designed via a computer simulation heuristic. An evolutionary design heuristic may be particularly appropriate. Computer simulations may also be used to optimize simple baffle designs in the context of turbulent flow, with or without the input of user data.

Referring now to FIG. 5, there is shown a second embodiment of a fluid-monitoring-probe assembly 328. For the sake of clarity, elements which are similar to those shown in the previous embodiment as shown in FIG. 2 have been assigned the same number plus three hundred, and further detailed description of such elements has been omitted for conciseness.

In this embodiment, there is provided the fluid-monitoring-probe assembly, indicated generally by 328, having a fluid-monitoring probe 314 comprising a probe flange element 332 adapted to engage with the inlet flange element 330 of the external neck portion 326 of the access port 316 of the pipe section 312. The probe flange element 332 further comprises an internal fluid conduit or passage 324 with inlet 348 and outlet 350. This internal fluid conduit 324 is principally advantageous in that it helps to maintain sub-cooling of the sampled fluid in the probe body 334. Preferably, it may be used to provide the sole secondary conduit, but it may also be appropriate to also include an additional secondary conduit, for example, through a support structure (not shown) around the probe body 334 in use, to improve the convection cooling. While the internal fluid conduit 324 is here shown as comprising three straight sections within the probe flange element 332, it may also preferably have a tortuous or helical path around the probe body 334.

The inlet 348 is located on the same side of the probe body 334 as the baffle 320, as the flow around the secondary conduit follows the pressure differential created by the baffle 320. The outlet 350 preferably extends into the internal volume of the access port 316 by means of an additional conduit section or nozzle 352. Preferably, the nozzle 352 is directed so that fluid expelled from the outlet 350 is directed towards the baffle 320, against the direction of the liquefied gas flow in the main throughbore 322 of the pipe section 312.

The baffle 320 is here provided as a curved metal plate, which ends in a preferably rounded, thicker, protrusion or tongue 354. The tongue 354 improves the performance of the baffle by reducing the tension on the baffle 320, aided by the backflow from the nozzle 352 of the outlet 350 as well as the eddy current of the fluid flow.

As before, a support structure, which is not shown in FIG. 5, may be utilised. Such a support structure may be beneficial for supporting the nozzle 352, and as such the nozzle may be integrally formed as a unitary one-piece part of the support structure, or may be fixedly attached thereto.

It is also feasible to incorporate the baffle 320, the passage 324 and/or the nozzle 352 as part of the fluid-monitoring probe. This may be by integrally forming, or may be by attaching the parts to the probe prior to installation.

It is therefore possible to provide a fluid monitoring system, in particular a liquefied natural gas pipeline monitoring system, which applies a baffle to redirect fluid from the liquefied gas flow in the main throughbore of the pipe along a passage defined around a fluid-monitoring probe. This beneficially allows the maintenance of a sub-cooled temperature at the fluid-monitoring probe, preventing or limiting partial vaporisation of a captured sample, for example, or retaining thermal equilibrium of a temperature probe with the bulk liquefied natural gas flow. Forcing an increased flow of cold, preferably sub-cooled bulk liquid into the connecting “port” or access port through which the sample probe is connected ensures that the probe is surrounded and in good thermal contact with the cooling fluid, thus providing improved cooling to the sample fluid flow within the probe up to the point where the probe penetrates the pipeline containment arrangement. Additionally, directing the flow in this manner will ensure that the “sealing arrangement” around the sample probe where it penetrates the pipeline is also cooled.

Furthermore, the passage around the fluid-monitoring probe may be advantageously defined by a support structure including a plurality of apertures, the design thereof resulting in control over the turbulence and velocity of the liquefied gas flow in the passage around the fluid-monitoring probe.

The words ‘comprises/comprising’ and the words ‘having/including’ when used herein with reference to the present invention are used to specify the presence of stated features, integers, steps or components, but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention herein described and defined.

1. A liquefied natural gas monitoring system comprising:
a section of a liquefied natural gas pipeline including a main throughbore, and an access port having a neck portion at least partially external to the main throughbore,
a fluid-monitoring probe insertable via the access port, and
a fluid-directing baffle;
wherein the fluid-directing baffle is mountable at or adjacent to the fluid-monitoring probe so as to direct the liquefied natural gas from the main throughbore of the pipeline into the neck portion of the access port, around the fluid-monitoring probe.

2. The liquefied natural gas monitoring system as claimed in claim 1, wherein the fluid-directing baffle is mounted on an interior surface of the pipeline and/or the access port.

3. The liquefied natural gas monitoring system as claimed in claim 1, wherein the fluid-directing baffle is mounted directly on the fluid-monitoring probe.

4. The liquefied natural gas monitoring system as claimed in claim 1, wherein the fluid-monitoring probe comprises an elongate monitoring element.

5. The liquefied natural gas monitoring system as claimed in claim 4, wherein the elongate monitoring element is at least partially enclosed by a support structure, wherein the fluid-directing baffle is mounted on the support structure.

6. The liquefied natural gas monitoring system as claimed in claim 5, wherein the support structure includes a plurality of apertures.

7. The liquefied natural gas monitoring system as claimed in claim 6, wherein the support structure includes at least two apertures distal to the main throughbore of the pipeline, to provide a fluid conduit path through the neck portion of the access port and via the support structure.

8. The liquefied natural gas monitoring system as claimed in claim 5, wherein the fluid-directing baffle is integrally formed with the support structure.

9. The liquefied natural gas monitoring system as claimed in claim 8, wherein the fluid-directing baffle is provided as an asymmetric extension of the support structure.

10. The liquefied natural gas monitoring system as claimed in claim 1, further comprising at least one indicator of the direction of fluid flow on the exterior of the access port and/or the fluid-monitoring probe.

11. The liquefied natural gas monitoring system as claimed in claim 1, wherein the fluid-directing baffle is either concave, or a flat or substantially flat plate.

12. A fluid-monitoring-probe assembly comprising: a fluid-monitoring probe which engages with a pipe to be monitored and a fluid-directing baffle; wherein the fluid-directing baffle is mountable at or adjacent to the fluid-monitoring probe so as, in use, to direct a fluid in the pipe around the fluid-monitoring probe.

13. The fluid-monitoring-probe assembly as claimed in claim 12, wherein the fluid-directing baffle is mounted directly on the fluid-monitoring probe.

14. The fluid-monitoring-probe assembly as claimed in claim 12, wherein the fluid-monitoring probe comprises an elongate monitoring element.

15. The fluid-monitoring-probe assembly as claimed in claim 14, wherein the elongate monitoring element is at least partially enclosed by a support structure, wherein the fluid-directing baffle is mounted on the support structure.

16. The fluid-monitoring-probe assembly as claimed in claim 15, wherein the support structure includes a plurality of apertures.

17. The fluid-monitoring-probe assembly as claimed in claim 16, where the support structure includes at least two apertures distal to a main throughbore of the pipe, to provide a fluid conduit path through the access port and via the support structure.

18. The fluid-monitoring-probe assembly as claimed in claim 14, wherein the elongate monitoring element is a liquefied natural gas sampling tube and/or thermowell.

19. The fluid-monitoring-probe assembly as claimed in claim 12, formed as a kit of parts.

20. A fluid-conduit baffle assembly configured for use with a fluid-monitoring-probe assembly having a fluid-monitoring probe and inside a fluid transfer conduit, the baffle assembly comprising: a support structure to which the fluid-monitoring probe can be mounted inside the fluid transfer conduit; and a fluid-directing baffle which is mountable to the support structure to direct fluid around or through the support structure.

21. (canceled)
